(19) United States
(12) Patent Application Publication
(10) Pub. No.: US 2010/0032909 A1
(43) Pub. Date: Feb. 11, 2010

(54) Engine Cylinder Head Gasket Assembly

(75) Inventor: Ted Beyer, Canton, MI (US)

Correspondence Address: Kristy J. Downing, Esq., 39555 Orchard Hill Pl., 6th Fl., PMB No.: 6051, Novl, MI, 48375, US

(73) Assignee: Ford Global Technologies LLC

(21) Appl. No.: 12/187,371

(22) Filed: Aug. 6, 2008

(51) Int. Cl. F02F 11/00

(52) U.S. Cl. 277/601

(57) ABSTRACT

The present disclosure relates to a cylinder head gasket assembly for an internal combustion engine. The gasket assembly includes a sheet configured to fit between a cylinder head and engine block, an annular bead formed in the sheet configured to maintain sealing pressure during combustion, and a shim coupled to the bead in a manner to concentrate axial loading during combustion. This gasket assembly maintains adequate sealing load while using fewer sheets (or layers). In many cases only one sheet enables sufficient sealing.

### TECHNICAL FIELD

The present disclosure relates to a cylinder head gasket assembly for an internal combustion engine.

### BACKGROUND

Conventional internal combustion engines typically utilize a cylinder head and engine block. During operation internal combustion engines generate high temperatures; high pressured gases are generated in the cylinder bores of the engine block. The cylinder bores can be sealed using various sealing mechanisms to reduce the amount of gases that leak from the cylinder bore. If combustion gases leak from the cylinder bore, the gas may enter into one of the other orifices in the engine block. This may result in a loss of engine power and degrade the effectiveness of the cooling system. Therefore, it is desirable to effectively seal the combustion chamber. It is also desirable to have an engine gasket assembly with reduced material costs while providing adequate sealing.

### SUMMARY

In one exemplary embodiment, a cylinder head gasket assembly for an internal combustion engine includes: a sheet configured to fit between a cylinder head and engine block; an annular bead formed in the sheet configured to maintain sealing pressure during combustion; and a shim coupled to the bead in a manner to concentrate axial loading on the assembly during combustion.

In another exemplary embodiment, a cylinder head gasket assembly for an internal combustion engine includes: a sheet configured to fit between a cylinder head and an engine block; and a shim coupled to the sheet. The shim is biased with respect to the sheet in a manner to maintain sealing pressure and concentrate axial loading on the assembly during combustion.

In another exemplary embodiment, an internal combustion engine includes: an engine block having a plurality of cylinder bores; a cylinder head mounted with respect to the engine block; and a cylinder head gasket assembly fitted between the engine block and cylinder head. The gasket assembly includes: a sheet configured to fit between the engine block and cylinder head; and a shim coupled to the sheet configured to concentrate axial loading on the assembly during combustion. The shim is biased with respect to the sheet in a manner to maintain sealing pressure during engine combustion.

One advantage of the present invention is that the gasket assembly seals the cylinder bore better than prior art designs while using fewer parts and lower manufacturing costs. For example, the exemplary embodiments disclosed herein employ a single-sheet arrangement thereby requiring fewer parts than a multi-sheet assembly. The resulting reduction in gasket thickness minimizes chamber crevice volume as well thereby reducing CO₂ emissions in the engine exhaust. Accordingly, the present invention also increases fuel efficiencies and overall engine performance.

Another advantage of the present invention is that it reduces extremities in the pressure distribution across the sheet at the cylinder bores. In this manner, it provides greater durability for the gasket assembly and overall engine.

The present invention provides a snug fit between the components of the gasket assembly. An annular bead with a semi-circular shaped profile is formed in the sheet, therefore better accommodating assembly, combustion and thermal loads than prior art arrangements.

Another advantage of the present invention is that it enables sealing without requiring complicated resin applications. In this manner, manufacturing and assembly of the gasket assembly is considerably simplified.

The invention will be explained in greater detail below by way of example with reference to the figures, in which the same references numbers are used in the figures for identical or essentially identical elements. The above features and advantages and other features and advantages of the present invention are readily apparent from the following detailed description of the best modes for carrying out the invention when taken in connection with the accompanying drawings. In the figures:

### BRIEF DESCRIPTION OF THE DRAWINGS

FIG. 1 is an exploded view of a vehicle engine with gasket assembly according to an exemplary embodiment of the present invention.

FIG. 2 is a perspective view of the gasket assembly of FIG. 1.

FIG. 3 is a perspective view of the gasket assembly of FIGS. 1 and 2 showing an orifice that corresponds to an engine cylinder bore.

FIG. 4 is a cross-sectional view of a cylinder head and engine block with gasket assembly therebetween according to an exemplary embodiment of the present invention.

FIG. 5 is a cross-sectional view of a gasket assembly according to an exemplary embodiment of the present invention.

FIG. 6 is a graph of the stress distribution on the sheet of a gasket assembly during engine operation according to an exemplary embodiment of the present invention.

### DETAILED DESCRIPTION

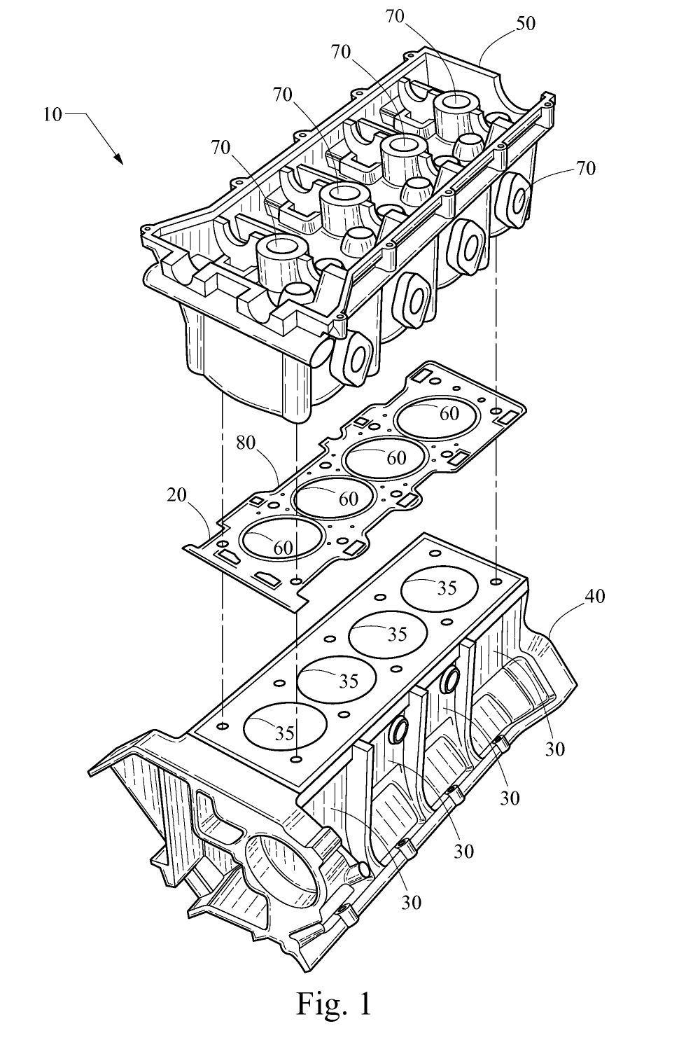

Referring to the drawings, FIGS. 1 through 6, wherein like characters represent the same or corresponding parts throughout the several views there is shown an internal combustion engine 10 with gasket assembly 20 for use therein. The engine is an in-line arrangement, having four cylinders assemblies 30. The engine includes an engine block 40 configured to house the multiple cylinder assemblies 30. Each cylinder assembly 30 includes a cylinder bore 35. Internal combustions occur in the cylinder bores 35 between the engine block 40 and cylinder head 50.

A gasket assembly 20 is placed between the engine block 40 and cylinder head 50. The gasket assembly 20, shown in FIG. 1, includes four combustion orifices or openings 60 configured to line up with the cylinder bores 35 and fit between the cylinder head 50 and engine block 40. A cylinder head 50 fits on top of the gasket assembly 20. The cylinder head 50 encloses the cylinder bores 35 in the engine block 40. The cylinder head 50 includes a plurality of orifices (e.g., 70) for various engine components, such as spark plugs, fuel injectors, valves, oil passages, water passages, etc. The gasket assembly 20 acts as a more efficient seal for the cylinder bore 35 during engine operation.

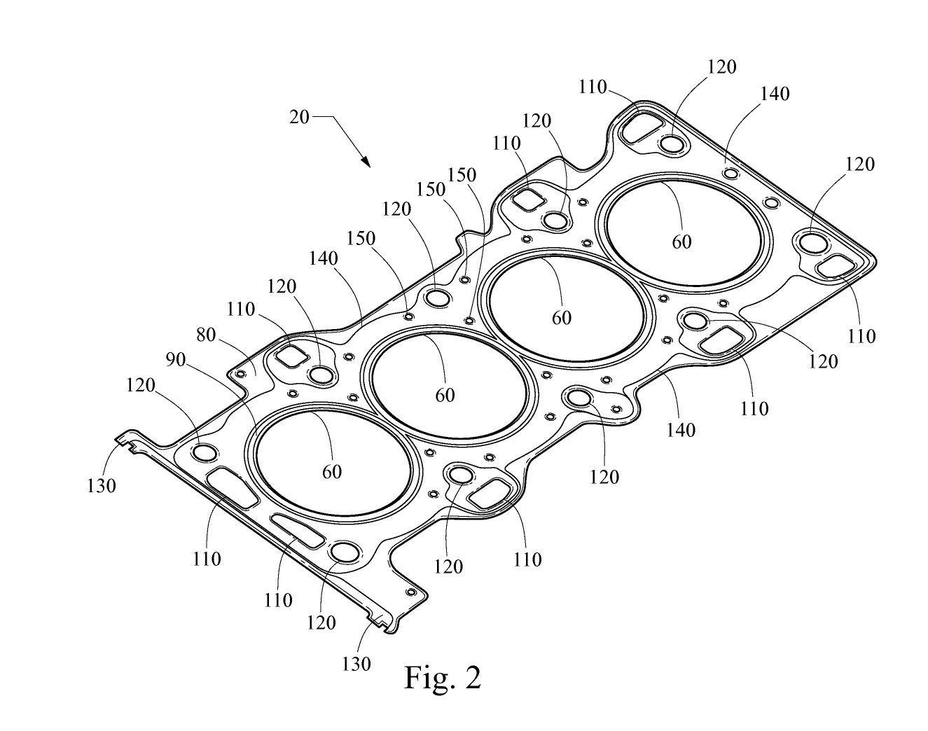

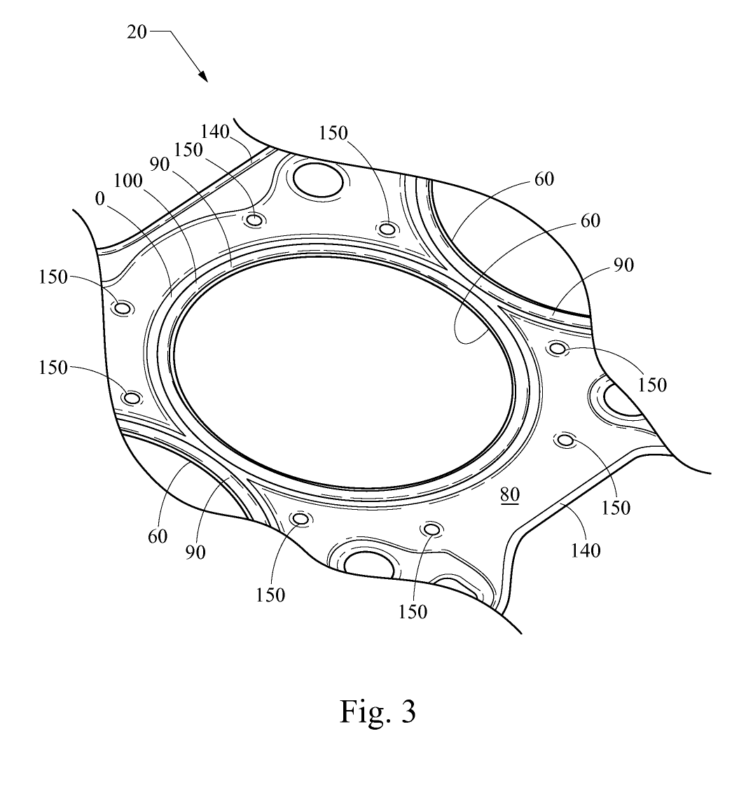

Shown in FIGS. 2-3 is the gasket assembly 20 of FIG. 1. The gasket assembly 20 is configured for use in an internal combustion engine (e.g., 10 as shown in FIG. 1). The assembly 20 includes a sheet 80. In the illustrated embodiment, the sheet 80 is composed of metal. The sheet 80 has several combustion orifices 60 that correspond to various cylinder bores, e.g. 35 as shown in FIG. 1. Each combustion orifice 60 includes a number of sealing components. For example, the assembly 20 includes an annular bead 90 (or protrusion) that surrounds the combustion orifice 60, as illustrated in FIG. 2. The bead 90 is formed in the sheet 80 and protrudes from the face of the sheet 80. The bead 90 is deformable with respect to the sheet 80 when placed under high stress. In this way, the bead 90 has elastic properties and acts as an elastic member or spring, absorbing the axial loading placed on the assembly during engine combustion. The assembly only includes one sheet 80. In one embodiment, the bead 90 and shim 100 are configured to maintain a sealing pressure/load of at least 50 N/mm.

The spring rate can be altered in various ways. For example, the shape of the profile of the bead can be altered to increase or decrease the stiffness of the bead 90. Different materials can be selected to accommodate a desired spring rate. The dimensions of the profile (or cross-section) of the bead can be configured to achieve a higher or lower spring rate. Alterations to the dimensions of the components of the gasket assembly can also be made to adjust the stiffness of the bead-shim coupling. For example the sheet thickness, bead width, bead height, profile shape, and shim height can be adjusted to alter the stiffness of the bead-shim coupling.

The sheet 80 is configured to fit between the engine block 40 and cylinder head 50 (as shown in FIG. 1). The sheet 80 also includes a shim 100 (or stopper), as shown in FIG. 2, that is coupled to the annular bead 90. In the illustrated embodiment, the shim 100 is mounted on top of the bead 90. In another embodiment, the bead 90 is mounted on top of the shim 100. In this manner, the shim 100 is configured to concentrate the axial load placed on the gasket assembly 20 during combustion. The shim 100 acts as a support member. The bead 90 is deformable; accordingly the shim 100 is axially biased with respect to the sheet 80 by the annular bead 90. In this manner, the shim 100 is configured to maintain sealing pressure during engine combustion. The shim 100 and bead 90 are axially coupled together in a manner to concentrate the axial loading placed on the assembly. In the illustrated embodiment, the shim 100 and bead 90 have similar diameters so that the shim 100 is coaxially aligned with the bead 90 and rests on top of the bead. The gasket assembly enables an even load distribution around the combustion orifices 60. The relatively low stiffness of the shim 100 and bead 90 coupling results in a compliant sealing system. The gasket assembly 20 is a single sheet arrangement as shown in FIG. 2. Only one metal sheet or layer is included in the gasket assembly 20 thus the assembly includes fewer parts than many prior art designs.

The sheet 80 includes secondary orifices e.g., 110 and 120. Orifices 110 are used for draining oil back from the cylinder head to the cylinder block. Orifices 120 are used to fit bolts from the cylinder head 50 through to the engine block 40 (as shown in FIG. 1). Sheet 80 includes two protrusions/beads 130 formed in the sheet. The beads 130 are used to seal the engine's front cover. The sheet 80 further includes a number of additional beads or protrusions 140 that surround the perimeter of the sheet. Beads 140 act as a secondary sealing mechanism within the gasket assembly 20. The sheet 80 also includes a number of orifices 150, as shown on FIG. 3, that act to cut material costs for the overall gasket assembly.

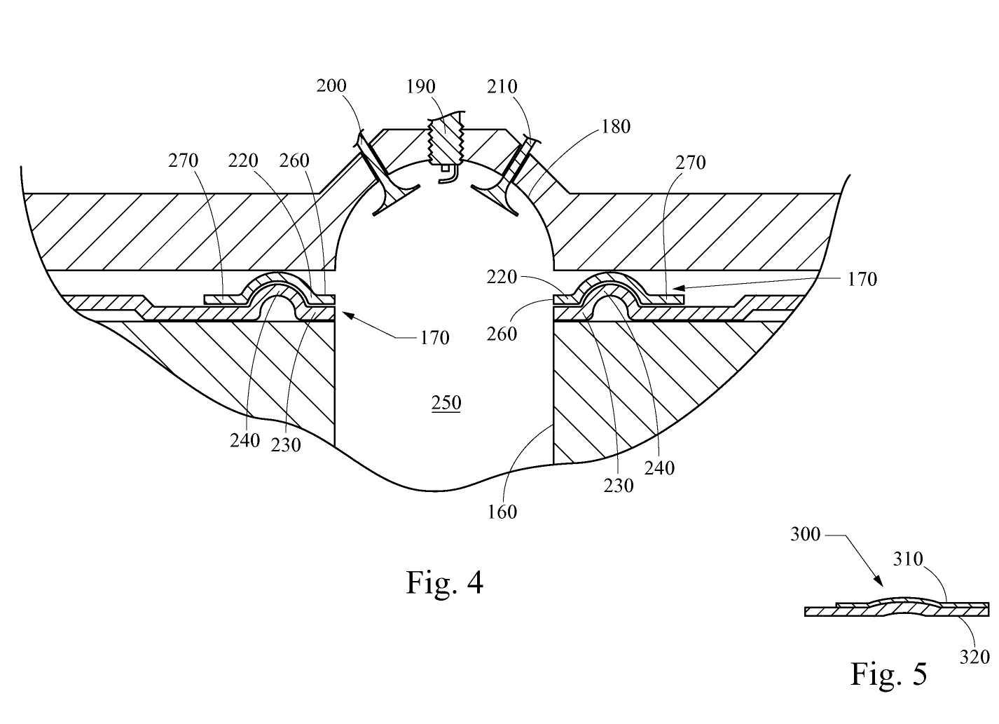

FIG. 4 is a cross-sectional view of an engine block 160, gasket assembly 170 and cylinder head 180 according to an exemplary embodiment of the present invention. The bead 240 has a semi-circular profile shape as shown in FIGS. 4 and 5.

The illustrated embodiment of FIG. 4 includes a spark plug 190 with intake and exhaust valves 200, 210 in the cylinder head 180. The cylinder head 180 rests on top of the gasket assembly 170. In this embodiment, the gasket assembly 170 includes a shim 220 coupled to the bead 240. The sheet 230 includes a bead or protrusion 240 that runs annularly with respect to a cylinder bore 250. The bead 240 shown has a semi-circular shaped profile; however, in another embodiment the bead has a rectangular shaped profile. The profile shape of the bead 240 can vary.

The radius of curvature of the shim 220 and bead 240 in the sheet 230 can be larger or greater than that shown in FIG. 4. For example, FIG. 5 illustrates another embodiment of a gasket assembly with shim 310 and sheet 320 having a bead 300 formed therein. In the illustrated embodiment, the shim 220 includes two flanged edges 260, 270 that form the inner and outer diameter of the shim.

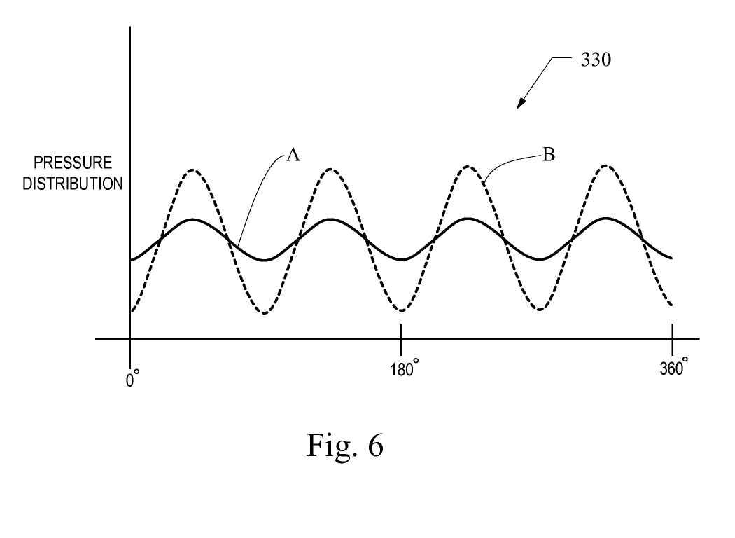

FIG. 6 shows a graph 330 that illustrates the stress distribution on a sheet of a gasket assembly during engine operation, according to an exemplary embodiment. The data is taken from an original point “O” on the sheet 80 of the gasket assembly 20 (as shown in FIG. 3). O is equal to zero degrees on graph 330 shown in FIG. 6. Line A represents the pressure or stress distribution on the sheet of the gasket assembly. The assembly includes a shim mounted on top of a bead or protrusion that surrounds a cylinder bore. The design represented by Line A does not include a second sheet. However, the arrangement represented by Line B includes multiple sheets. The arrangement represented by Line B further includes a shim and annular bead that are not coupled together. The maximum and minimum stress across the sheet of the combustion orifice is less than an arrangement employing two sheets as shown by the line B. The present techniques reduce extremities in the pressure distribution at a combustion opening. In this way, the present techniques provide a better seal. Additionally, engine parts are subjected to much less stress and wear yielding greater durability and overall performance.

In one embodiment, the assemblies, e.g., 20 and 170, further include a coating of material that is sprayed along the perimeter of the combustion orifices 60. The coating material can also be selectively sprayed at other points on the sheet. In another embodiment, the coating is screen printed on the sheet. In one embodiment, the coating is composed of a compressible sealing material, such as rubber. In another embodiment, the coating is composed of a harder material such as a resin, fluoroplastic or plyamidcimido. The coating can be uniformly applied. In the illustrated embodiment, the coating material is of uniform thickness. The coating material can have a gradual thickness. For example, the coating material may be thicker at the end of the combustion opening but thinner at the bead and shim. The coating material can also be thicker on an outer diameter of the shim to support the seal without adding height to the gasket assembly.

Sheets 80, 230, 320 can be manufactured using a number of techniques. For example, in one embodiment, the sheet is stamped. In another embodiment, the sheet is laser cut and the bead is formed at the combustion opening. The bead can be formed in the sheet using any number of manufacturing techniques, such as stamping, crimping, etc. The shim can be attached to the sheet via laser welding for example. The sheet can be formed of a variety of materials such as metal alloys. In one embodiment, the sheet is formed of a metallic composite such as stainless steel (e.g., SS 301). Other Chromium-Nickel steels capable of attaining high strength with moderate cold working can be employed. In one embodiment, the sheet is formed of a 0.25 mm thick sheet of SS 301. The metallic components of the gasket assembly are laminated. The shim is composed of a metallic material. In one embodiment, the shim is composed of a 0.100 mm 301 SS. The thickness of each component is variable and not limited to the dimensions disclosed herein.

While the shims 100, 220 and 310 shown in the illustrated embodiments are shown on top of the bead, the shim may be constructed to define a space between the shim and the bead. For example, in one embodiment the shim and bead include a gap or spacing between them. The shim can also be placed beneath (or underneath) the bead in an alternative embodiment. An additional embodiment includes more than one shim to act as a support member to the gasket assembly. The shim and/or sheet can also be formed so that multiple layers of metal are provided at the combustion orifice without requiring a substantial amount of additional material. In one embodiment, multiple shims are coaxially mounted with respect to the axial bead. The shims and bead have substantially similar diameters so that the shims can be stacked on top of or underneath the bead. In this manner, additional support is provided to the bead without requiring multiple sheets. The shim can be formed using a number of manufacturing techniques such as e.g., laser cutting, stamping, etc. The shim can be attached to the sheet via press fitting, stamping, welding, gluing, etc.

The invention has been described with reference to certain aspects. These aspects and features illustrated in the drawings can be employed alone or in combination. Modifications and alterations will occur to others upon a reading and understanding of this specification. Although the described aspects discuss steel as one material of construction, it is understood that other materials can be used for selected components if so desired. It is understood that mere reversal of components that achieve substantially the same function and result are contemplated, e.g., biasing the shim with respect to the sheet of the gasket assembly can be achieved via various configurations without departing from the present invention. It is intended to include all such modifications and alterations insofar as they come within the scope of the appended claims or the equivalents thereof.

While several examples for carrying out the invention have been described, those familiar with the art to which this invention relates will recognize alternative designs and embodiments for practicing the invention. Thus, the above-described embodiments are intended to be illustrative of the invention, which may be modified within the scope of the following claims.

What is claimed is:

1. A cylinder head gasket assembly for an internal combustion engine, comprising:
a sheet configured to fit between a cylinder head and engine block;
an annular bead formed in the sheet, configured to maintain sealing pressure during combustion; and
a shim coupled to the bead in a manner to concentrate axial loading on the assembly during combustion.

2. The assembly of claim 1, wherein the annular bead has elastic properties.

3. The assembly of claim 2, wherein the annular bead is a spring.

4. The assembly of claim 3, wherein the shim is coupled to the annular bead in a manner to maintain a sealing pressure of at least 50 N/mm during engine operation.

5. The assembly of claim 1, wherein the shim is mounted on top of the annular bead.

6. The assembly of claim 1, wherein the annular bead is mounted on top of the shim.

7. The assembly of claim 1, wherein the annular bead has a semi-circular shaped profile.

8. The assembly of claim 1, wherein the gasket assembly is a single sheet arrangement.

9. A cylinder head gasket assembly for an internal combustion engine, comprising:
a sheet configured to fit between a cylinder head and an engine block; and
a shim coupled to the sheet;
wherein the shim is biased with respect to the sheet in a manner to maintain sealing pressure and concentrate axial loading on the assembly during combustion.

10. The assembly of claim 9, wherein the support member is axially biased by an annular bead formed in the sheet.

11. The assembly of claim 10, wherein the annular bead has a semi-circular shaped profile.

12. The assembly of claim 10, wherein the shim is mounted on top of the annular bead.

13. The assembly of claim 10, wherein the annular bead is mounted on top of the shim.

14. The assembly of claim 10, wherein the shim is coupled to the annular bead in a manner to maintain a sealing pressure of at least 50 N/mm during engine operation.

15. The assembly of claim 9, wherein the gasket assembly is a single sheet arrangement.

16. An internal combustion engine, comprising:
an engine block having a plurality of cylinder bores;
a cylinder head mounted with respect to the engine block;
a cylinder head gasket assembly fitted between the engine block and cylinder head, the gasket assembly including:
a sheet configured to fit between the engine block and cylinder head; and
a shim coupled to the sheet, configured to concentrate axial loading on the assembly during combustion, wherein the shim is biased with respect to the sheet in a manner to maintain sealing pressure during engine combustion.

17. The engine of claim 16, wherein the shim is axially biased by an annular bead formed in the sheet.

18. The engine of claim 17, wherein the annular bead has a semi-circular shaped profile.

19. The engine of claim 17, wherein the shim is mounted on top of the annular bead.

20. The engine of claim 16, wherein the gasket assembly is a single sheet arrangement.
